(19) United States
(12) Patent Application Publication
(10) Pub. No.: US 2006/0113162 A1
(43) Pub. Date: Jun. 1, 2006

(54) Validator guide

(76) Inventors: Kenneth Ottesen, Schaumburg, IL (US); Thomas Costanzo, Elmhurst, IL (US)

Correspondence Address: WEIDE & MILLER, LTD., 7251 W. LAKE MEAD BLVD., SUITE 530, LAS VEGAS, NV, 89128, US

(21) Appl. No.: 10/998,446

(22) Filed: Nov. 29, 2004

(51) Int. Cl. G07F 9/10

(52) U.S. Cl. 194/350

(57) ABSTRACT

A guide has a body configured to be connected to validator having media-accepting slot having a first angle of insertion. The guide has a media guide surface, the media guide surface configured to direct a media into the validator when a media is presented at a second angle of insertion which is offset from the first angle of insertion. In one embodiment, the guide is configured to be connected to a bezel of the validator, the bezel defining an opening leading to the media-accepting slot. The validator may be a currency validator. The media guide surface may have a variety of configurations, permitting specific selection of the new angle of insertion relative to the normal angle of insertion.

### FIELD OF THE INVENTION

The present invention relates to validators of the type used to validate media such as currency and tickets and, more particularly, to a device for guiding media into the validator.

### BACKGROUND OF THE INVENTION

Validators are commonly used to confirm the authenticity of or to otherwise obtain information from various media. Generally, the media comprises currency or “bills,” but may comprise paper tickets or other currency substitutes.

The validators are generally configured to read or scan the media to obtain information therefrom. The information obtained from the media may be used for a variety of purposes. If the media is found to be fraudulent, it may be rejected. If the media is found to be authentic, the validator may provide information regarding a value associated with the media. For example, a validator may scan a $20 bill, determine that the bill is authentic and then provide information to another device regarding the acceptance of $20 in value from the provider of the bill.

Validators are commonly utilized in situations where a party must provide value in order to obtain a good or service. These applications include vending machines, change-making machines, and gaming machines, among others.

Validators generally include a slot in a face thereof through which the media is inserted. Once inserted into the slot, the media is fed into the validator to a scanner or reader. If the media is accepted, it may be routed to a secure container for storage and later retrieval. If the media is rejected, it is expelled outwardly from the validator back through the slot towards the user.

The validators are constructed with a secure housing so as to protect the internal components and stored media. The housing has a vertical front face. The media-accepting slot is generally located in the front face of the validator housing. The slot lies in a horizontal plane and is configured to accept a media which is horizontally aligned with the slot. Such a validator configuration is illustrated in FIG. 1 for reference.

Unfortunately, this validator configuration has several drawbacks. One primary drawback is that in many applications the validator must be oriented in other than its normal upright position. For example, it is common in gaming machines, especially those of the slant-top type, for the top or front surface of the machines which faces the player to extend at an angle. In order for the slot of the validator to align with a slot formed in that top surface, the validator must be tipped backwardly. The slot then faces upwardly towards vertical. This makes it difficult for the user to align the media with the slot.

### SUMMARY OF THE INVENTION

The invention is a guide and, more particularly, a guide for a media validator. Preferably, the guide is configured to change the angle of entry of a media into media-accepting slot of a validator.

In one embodiment, the guide has a body configured to be connected to validator having media-accepting slot having a first angle of insertion. The guide has a media guide surface, the media guide surface configured to direct a media into the validator when a media is presented at a second angle of insertion which is offset from the first angle of insertion.

In a preferred embodiment, the guide is configured to be attached to a bezel associated with the validator. The bezel defines an opening which leads to the media-accepting slot of the validator. The guide changes the angle or orientation of insertion from that of the opening in the bezel.

In one embodiment, the guide has a pair of legs which are configured to extend into the opening in the bezel to connect the guide to the bezel. The media guide surface is located between the legs.

In one embodiment, the guide has a face which obscures at least a portion of the opening in the bezel and/or slot of the validator, thereby requiring that the media be presented to the validator at a different angle in order to be accepted. Preferably, the media guide surface directs the presented media from the new angle or orientation into the opening or slot. In one embodiment, the guide surface is curved.

The guide may be configured to change the angle or orientation of insertion by any amount. For example, when considering a normal angle or position of insertion at horizontal or zero (0) degrees, the guide may change the angle of insertion by any amount over zero (0) degrees, such as one (1) degree or one-hundred (100) degrees.

Preferably, the guide is selectively connected to the bezel and/or validator. In this manner, guides having different configurations may be interchanged or selectively chosen to achieve the desired angle or orientation of insertion.

The guide has a number of advantages and uses. In one embodiment, a validator may have media-accepting slot which lies in a horizontal plane when the validator is in a normal position. In use, however, the validator may be oriented at an angle, thus causing the slot, and thus the angle of insertion, to be in an undesired orientation. For example, in a gaming machine, the validator might be tipped rearwardly such that the slot faces upwardly. In that instance, a guide may be connected to the validator to change the angle or orientation of media insertion to another position, such as generally horizontal.

Further objects, features, and advantages of the present invention over the prior art will become apparent from the detailed description of the drawings which follows, when considered with the attached figures.

### DESCRIPTION OF THE DRAWINGS

FIG. 1 illustrates a media validator in accordance with the prior art;

FIG. 2 illustrates a validator guide of the present invention associated with a bezel of a media validator;

FIG. 3 is a first perspective view of a validator guide in accordance with one embodiment of the invention;

FIG. 4 is a second is a second perspective view of the validator guide illustrated in FIG. 3;

FIG. 5 is a perspective view of a validator guide in accordance with another embodiment of the invention;

FIG. 6 illustrates a media insertion orientation for a validator having a bezel without a validator guide in accordance with the present invention;

FIG. 7 illustrates a media insertion orientation for a validator having a bezel and associated validator guide in accordance with one embodiment of the invention; and

FIG. 8 illustrates a media insertion orientation for a validator having a bezel and associated validator guide in accordance with another embodiment of the invention.

### DETAILED DESCRIPTION OF THE INVENTION

The invention is a guide for a validator. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a guide for a media validator. In one embodiment, the guide connects to an existing validator and is configured to change the angle or position at which media is presented to the validator. The guide guides the media into a media accepting slot of the validator.

In one embodiment of the invention, a guide is configured to define an angle or position of insertion of a media to a media validator. This angle or position of insertion differs from that defined by the slot or other media accepting opening of the validator.

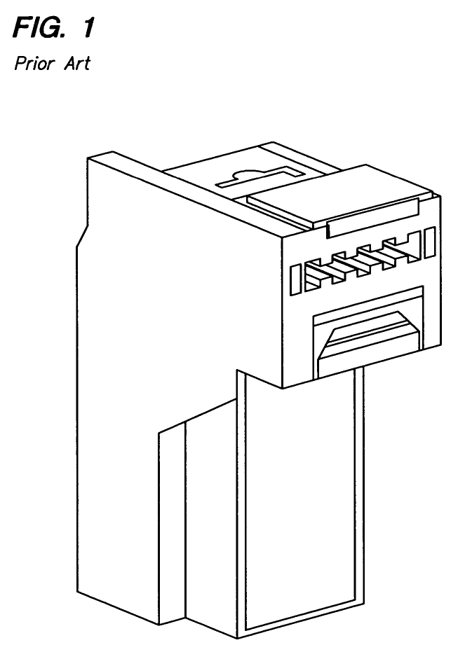

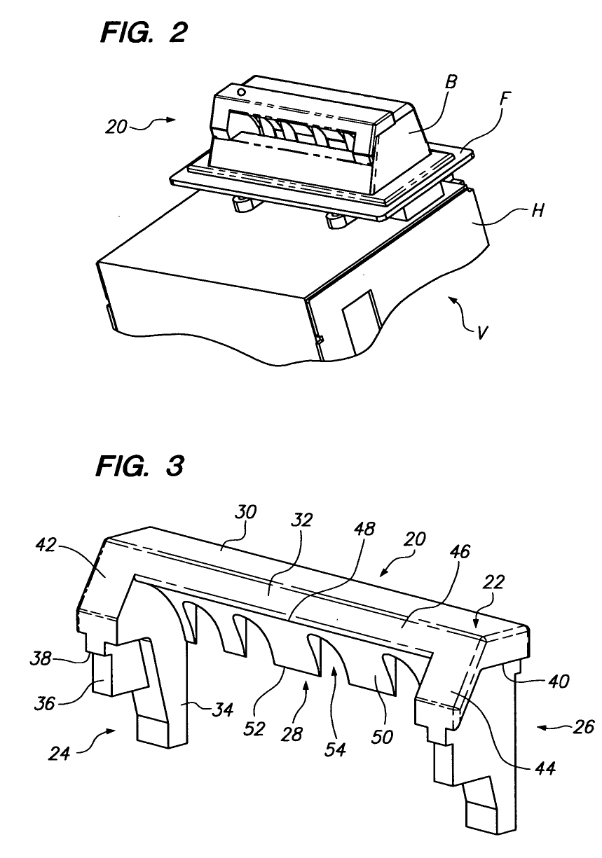

In a preferred embodiment, the guide is configured to be associated with a bezel of a validator. FIG. 2 illustrates such a configuration. As illustrated, a validator V includes a housing H. A slot (not illustrated, but visible in FIG. 1) is formed in a face F of the validator. The slot is oriented perpendicular to the face F, such that when the face F is in a vertical plane, the slot is located in a horizontal plane.

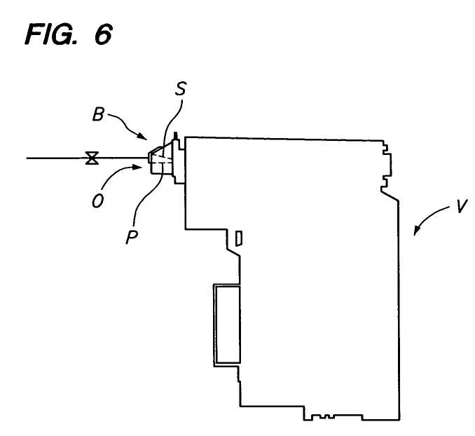

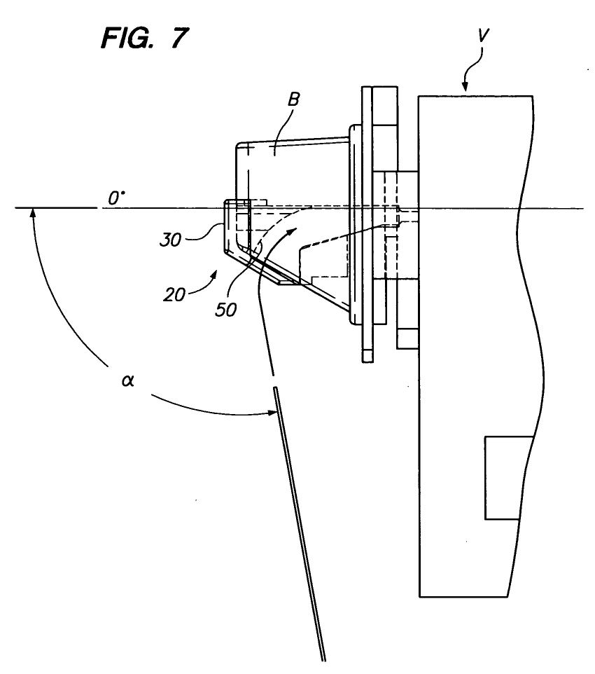

A bezel B is connected to the face F. The bezel B defines an opening through which media may be inserted into the slot. In general, this opening is larger than the size of the slot. The opening is defined by opposing sides and ends, namely a top and a bottom sides or surface, and left and right ends. Generally, the sides are spaced apart by a greater distance than the height of the slot in the face F of the validator V. As illustrated, one of the sides or surfaces is generally planar, defining the horizontal angle of insertion into the media accepting slot of the validator. The other side or surface may be angled, so that the size of the opening at the exterior of the bezel is larger than the media-accepting slot in the validator. This configuration has the advantage that it substantially lessens the difficulty of a user having to align a media with the narrow slot in the validator by providing a larger or wider opening through which the media may be accepted. In this configuration, as illustrated in FIG. 6, the angle of insertion into the validator is defined by the planar interior surface of the bezel, which thus defines a horizontal angle of insertion which is aligned with the media accepting slot in the validator.

As illustrated, the invention comprises a guide 20 which is associated with the bezel B. The guide 20 is, as described in more detail below, configured to change the angle or position at which a media must be presented to the validator V in order for it to be accepted to the validator and, more particularly, the media accepting slot of the validator.

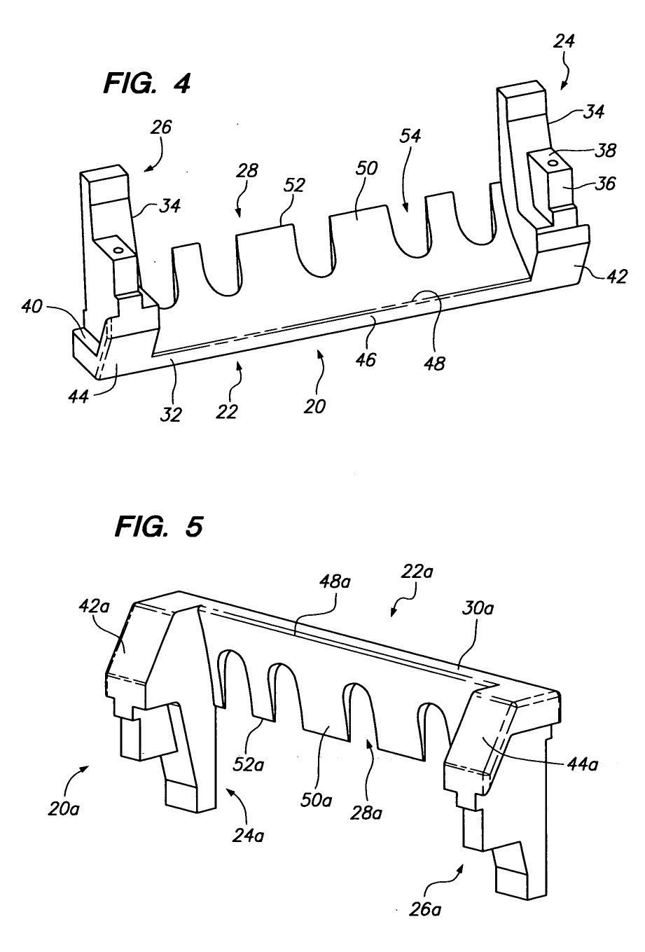

FIGS. 3 and 4 illustrate one embodiment of the guide 20 of the invention. In one embodiment, the guide 20 is defined by a body having a front face 22, a pair of spaced legs or supports 24,26, and a media guide surface 28.

The front face 22 defines the portion of the guide 20 which is exposed and generally faces the user of the validator 20 when the guide 20 is connected thereto, as best illustrated in FIG. 2. In one embodiment, the front face 22 has a first portion 30 which is generally planar, and a second portion 32 which is also generally planar, but which is located in a plane which is offset from a plane containing the first portion. As described below, the front face 22 preferably blocks all or a portion of the opening into the bezel or slot in the validator, thus necessitating that the media be presented at a different angle or direction of insertion.

In one embodiment, the front face 22 has a first side and an opposing second end. The legs 24,26 extend outwardly from the ends of the front face 22. In this manner, as illustrated, the legs 24,26 are spaced apart from one another.

In one embodiment, the legs 24,26 serve as the primary means for connecting the guide 20 to the validator. Thus, the exact configuration of the legs 24,26 may vary depending upon the bezel and/or validator to which the guide 20 is to be connected.

Referring to FIG. 6, in one embodiment, the top and the bottom of the slot or opening O in the bezel B is defined by a first planar surface P and a second slanted surface S. The slot or opening O is thus wider than the media which it is designed to accept, as described in greater detail above. The opening O in the bezel also has a pair of opposing ends.

In one embodiment, the legs 24,26 of the guide 20 are configured to be inserted into the opening O in the bezel B so as to engage the bezel. Preferably, the legs 24,26 are located at opposing ends of the slot or opening in the bezel, and media is configured to be accepted therebetween.

As illustrated, the legs 24,26 comprise a main body or first portion 34 and a key or second portion 36. The legs 24,26 extend rearwardly from the front face 22 of the guide 20. The legs 24,26 have an inner surface and an outer surface. Referring to FIG. 3, the outer surface of the key 36 and main body 34 of each leg 34,36 is preferably common, and inset from a side or edge of the front face 22. In this configuration, the front face 22 and inset legs 24,26 define a step or flange 40 at each side of the guide 20.

The main body 34 and key 36 of the legs 24,26 define an inner surface of the legs 24,26. The position or location of the inner surface of the legs 24,26 varies.

As illustrated, the main body or first portion 34 of each leg 24,26 extends from the front face 22. At the front face 22, the main body or first portion 34 of each leg 24,26 is generally the same height as the front face 22. The main body or first portion 34 generally reduces in height moving in a direction away from the front face 22 of the guide 20. In one embodiment, as illustrated, the height of the main body 34 drops sharply at a ledge, then slopes downwardly to flat or tab portion of the leg 34,36.

The main body or first portion 34 of each leg 24,26 defines a smooth inner surface of the legs 24,26 at either side of the media guide surface 28.

The key 36 extends upwardly from the sloping portion of each leg 24,26 from the ledge thereof. As illustrated, the key 36 has a width which is less than that of the main body 36. In this configuration, the inner surface of each leg 24,26 at the key 36 is inset from the remaining inner surface of each leg 34,36. In one embodiment, as illustrated, the top of the key 36 has a step or notch 38.

As illustrated, the second portion 32 of the front face 22 of the guide 20 is generally “C”-shaped. A pair of end or wing portions 42,44 extend at an angle from the first portion 30 of the front face 22. A center section 46 of the second portion 32 of the front face 22 is preferably similar angled or slanted and extends between the wings 42,44. The center section 46 of the second portion 32 of the front face 22 defines a lip 48.

The media guide 28 preferably defines a guide surface 50 which is configured to contact and guide a media which is presented to a media validator. As illustrated, the media guide 28 extends rearwardly from the front face 22 of the guide 20. The media guide 28 is located between the legs 24,26 of the guide 20.

In one embodiment, the media guide 28 is generally triangular in shape, having an area of increased thickness at the front face 22 and tapering in thickness traveling outwardly therefrom. The guide surface 50 has a first or leading edge which is generally co-extensive with the lip 48 of the front face 22. The guide surface 50 also has a terminating edge 52. In this configuration, the elevation of the leading and terminating edges thus differs.

In a preferred embodiment, the total area of the guide surface 50 is minimized by a plurality of cut-outs 54 in the media guide 28. In one embodiment, each cut-out 54 is “U” or arch-shaped. As illustrated, there are four such cut-outs. There may be a greater or lesser number of cut-outs, and their location and shape may vary.

In a preferred embodiment, the guide surface 50 is sloped and, more preferably somewhat curved, arched or arcuate. The particular shape or configuration of the guide surface 50, and thus the media guide 28 which defines it, varies depending upon the desired angle of media entry, as detailed below.

As detailed, the angle of curvature of the guide surface 50, as dictated in large part by the height of the first or leading edge of the guide surface 50 from the bottom of the front face 22, thus changes depending upon the desired insertion angle.

As illustrated, the terminating edge 52 of the media guide 28 is set inwardly from the end of the legs 24,26. The actual length of the media guide 28, however, may vary. In general, the length of the media guide 28 is selected so that, when considering the angle of curvature of the guide surface 50, the guide surface 50 will readily guide a media along that surface to the slot or opening in the bezel. In this regard, when the guide 20 is connected to a validator, the terminating edge 52 of the media guide 28 preferably terminates at an interior surface of the bezel which defines the opening or slot, providing smooth transition of a media from the guide into the opening in the bezel and/or slot of the validator.

Additional aspects of the invention will now be described with reference to FIGS. 2, 7 and 8. As illustrated in FIG. 2, the guide 20 is configured to be connected to a validator V. In a preferred embodiment, the connection of the guide 20 is to a bezel B of the validator V.

When connected to the bezel B, the guide 20 cooperates with the bezel B to define an opening through which media may be inserted. Media inserted into this opening is directed into the validator V. As illustrated, one side of this opening is defined by the bezel B. The opposing side and the ends of the opening are defined by the guide 20.

Notably, in order for a media to be inserted into the validator V, it must be aligned with the opening, and more particularly, with the media guide 28 of the guide 20. This aspect of the invention is best understood with reference to FIGS. 6 and 7. As illustrated, without the guide 20, the direction of entry of a media into the validator V is along the horizontal, i.e. zero (0) degrees offset.

FIGS. 3 and 4 illustrates a guide 20 having a media guide 28 with a guide surface 50 which, at its interface with the front face 22, is offset from the horizontal by one-hundred (100) degrees. In this configuration, when the guide 20 is connected to a validator V as illustrated in FIG. 7, in order for a media to be accepted by the validator V, the user must present the media to the validator V at generally a one-hundred (100) degrees offset from horizontal.

As is clear, the front face 22 of the guide 20 obscures the normal opening into the bezel B of the validator V. In the preferred embodiment, the guide 20 blocks insertion of the media along the generally planar surface of the bezel or validator. Instead, the top of the opening into the validator V via the opening in the bezel B is defined by the media guide 28. In this embodiment, the opening thus generally faces downward.

In order to present a media M to the validator V, the user must locate the media M below the opening at an angle (α) of approximately one-hundred (100) degrees from horizontal. The user then directs the media M upwardly into the opening. As this occurs, the media encounters the media guide 28. The guide surface 50 of the media guide 28 cause the media to be directed towards horizontal and into the validator V.

In accordance with the invention, the guide 20 may have a variety of configurations. In particular, the guide 20 may be configured so that the angle of insertion of a media varies. In the embodiment just described and illustrated, the guide 20 was configured to change the angle of insertion by approximately one-hundred (100) degrees. The guide 20 could be configured to change the angle of insertion by other offsets or angles. The guide 20 could be configured to change the angle of insertion from any amount greater than zero (0) degrees.

For example, FIG. 5 illustrates another embodiment guide 20a which is configured to change the angle of insertion by one (1) degree. In the embodiment illustrated, the guide 20a is similar to that described above 20. The guide 20a thus has a front face 22a, a pair of legs 24a,26a, a media guide 28a including a media guide surface 50a extending between a leading edge 50a and terminating edge 52a, the front face having a pair of wings 42a,44a and a central portion 30a.

In this embodiment, the media guide surface 50a is generally planar, since the change in media orientation or angle effected by the surface 50a is only one degree. Once again, however, the front face 22a extends upwardly some distance to the leading edge 48a or lip, thus blocking at least portion of the normal opening in the bezel and forcing the user to slightly change the position at which a media is presented to a validator in order for it to be accepted.

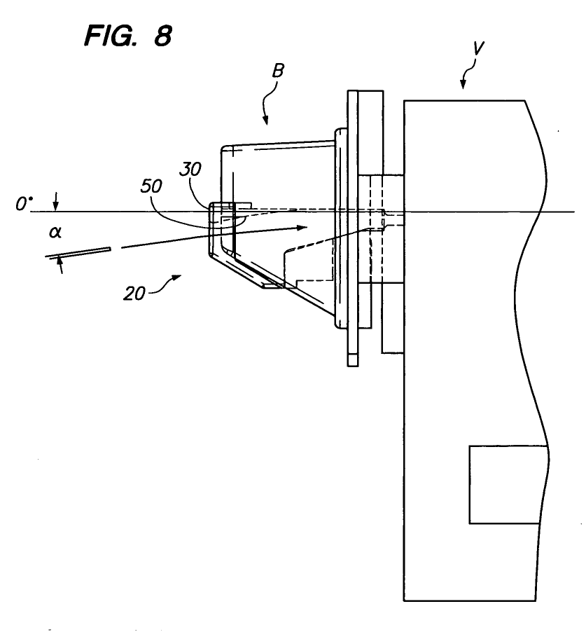

FIG. 8 illustrates a validator V having the guide 20a illustrated in FIG. 5 connected thereto. As indicated, in this configuration, the change in angle or orientation effected by the guide 20a is small, being about one (1) degree.

The invention has numerous advantages. The most significant advantage is that the guide can be used to change the angle of insertion of a media to a media validator. The invention has particular utility where it is necessary to change the angle of insertion to make the angle of insertion a convenient position. For example, in a slant-top type gaming machine, when the validator is installed, the media accepting slot may be oriented outwardly at approximately sixty (60) degrees from horizontal in the vertical direction (i.e. the validator is tilted backwards). This angle of insertion would force the player to reach out and attempt to align and guide the media downwardly into the validator. This may be difficult considering that the player's line of sight when seated will be generally horizontal towards the gaming machine.

In this configuration, a validator guide having an offset of approximately sixty (60) degrees may be associated with the validator. So associated, the angle of insertion is changed so that it is now generally horizontal, aligned with the player's line of sight.

One aspect of the invention is a guide which may be selectively connected to a validator, and most preferably, a bezel thereof. This configuration allows the guide which is associated with the validator to be changed. For example, a gaming machine operator may find that the particular offset provided by a particular guide is too little or too great of an offset. The operator may simply select a guide offering a different amount of offset. This solves complex problems which might otherwise be addressed only by changing the position of the entire validator, which is not possible once the machine has been developed and constructed.

The guide may have a variety of configurations. In one embodiment, the guide may be configured to be attached directly to a housing of a validator, rather than a bezel of the validator. For example, considering a configuration of a validator as illustrated in FIG. 1, the guide might have shorter legs and those legs may be configured to be connected directly to the validator so as to change the insertion angle from perpendicular to the housing as the slot is oriented in the validator housing. For example, the legs might include mounting holes for screws or clips to connect the guide to the validator housing.

The guide may be constructed of a variety of materials. In one embodiment, the guide is constructed of a durable plastic or similar material. The guide may be constructed of other materials, however, including more than one material. In one embodiment, the guide may be molded.

It will be appreciated that the orientation of the guide may vary. For example, in the embodiment illustrated in FIGS. 7 and 8, the guide is oriented so that the media must be inserted from below the guide. However, the guide could be connected to the validator so that the media guide faces upwardly, thus requiring that the media be directed downwardly into contact with the media guide.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A validator guide configured to guide a media into a media validator comprising:
a guide having a body configured to be connected to a bezel of said media validator, said bezel defining an opening through which a media may pass into said validator when said media is presented at a first angle of insertion, said guide having a media guide surface, said media guide surface configured to direct a media into said opening when said media is presented at a second angle of insertion offset from said first angle of insertion.

2. The validator guide in accordance with claim 1 wherein said body includes a pair of legs located on either side of a media guide, said media guide defining said media guide surface.

3. The validator guide in accordance with claim 1 wherein at least a portion of said guide prevents a media from passing into said opening when said media is presented at said first angle of insertion.

4. The validator guide in accordance with claim 1 wherein said media guide surface is arcuate.

5. The validator guide in accordance with claim 1 wherein said bezel has an interior surface defining said opening and said media guide surface terminates at said interior surface.

6. In combination, a media validator having a bezel and a validator guide, said validator including a slot through which a media may be passed, said bezel connected to said validator, said bezel having an opening aligned with said slot, said opening configured to permit a media to pass into said slot at a first angle of insertion, said validator guide having a media guide surface, said media guide surface configured to direct a media into said opening when said media is presented at a second angle of insertion offset from said first angle of insertion.

7. The combination in accordance with claim 6 wherein said media validator comprises a currency validator.

8. The combination in accordance with claim 6 wherein said opening in said bezel is defined by a first sloping side, a generally planar opposing said and a pair of ends.

9. The combination in accordance with claim 7 wherein said validator guide comprises a pair of spaced legs and a media guide located between said legs, said media guide defining said media guide surface, said legs configured to extend into said opening in said bezel along said ends thereof.

10. The combination in accordance with claim 6 wherein at least a portion of said guide prevents a media from passing into said opening when said media is presented at said first angle of insertion.

11. The validator guide in accordance with claim 6 wherein said media guide surface is arcuate.

12. A method of altering an angle of insertion of a media into a validator comprising:
providing a validator guide having a media guide defining a media guide surface, said media guide surface having a leading edge and a trailing edge, said leading and trailing edges of said media guide surface located at differing elevations; and
connecting said validator guide to a bezel of said validator such that said trailing edge of said media guide surface is co-extensive with a surface defining an opening in said bezel which leads to a media accepting slot of said validator.

13. The method in accordance with claim 15 including the step of inserting a pair of legs of said validator guide into said opening in said bezel.
